(19) United States
(12) Patent Application Publication
(10) Pub. No.: US 2011/0146524 A1
(43) Pub. Date: Jun. 23, 2011

(54) Modified Starch of Enhanced Water Soluble Dye Composition in Core Projectile and Method of Making

(76) Inventor: Tornee Pang, Kepong (MY)

(21) Appl. No.: 12/640,001

(22) Filed: Dec. 17, 2009

(51) Int. Cl. F42B 12/40; C09J 103/10; C08B 31/18; C08G 63/48

(52) U.S. Cl. 102/513; 106/208.1; 536/105; 554/1

(57) ABSTRACT

The present inventor has discovered a new combination composition using modified oxidized starches blended with shortening oil FL30™ and vegetables oil or combination of modified oxidized starches with polyethylene glycol attributed improvement in enhanced water soluble dye for encapsulation into impact ruptured projectile capsules. In a preferred embodiment of the enhanced composition, the aforesaid improvement over prior art of manufacturing native starches mixed with vegetables oil or polyethylene glycol is relates to significant chemical binding stability in the present of carbonyl and carboxylic groups, acetylation, cross-linked, physically modified, enzymatically modified, acid or alkaline treated and hydroxypropylation processes that can reduce retrogradation and syneresis, increased swelling power and solubility in free flowing attribution for greater splattering effect and completely washable solubility. The present invention is used in sports and leisure fields with a firing device of projectile air gun.

### BACKGROUND

In the past, lipophilic carrier used in fills material for preparing prior water soluble dye has been polyethylene glycol as the base for all ingredients.

Such prior art of using polyethylene glycol has caused many disadvantages which have been associated with this type of impact ruptured projectile capsules. For example, polyethylene glycol has been subject to significant interactions which may have been occurred between the polyethylene glycol based fill material and impact ruptured projectile capsules shell.

These interactions may have resulted, for example in substantially brittle surface of the impact ruptured projectile capsules shell which has been subject to an increased risk of shattering whilst being fired from projectile air gun device. Therefore there is a significant storage requirement associated in handling this prior art polyethylene glycol fills based.

Other disadvantage associated with such prior art of polyethylene glycol based has been the escalating high cost due to high content of polyethylene glycol composition used in the preparation of the prior water soluble dye.

Among other disadvantages associated with the prior art include tenacious or permanent staining of target fabrics, freezing and solidification of the paint composition during exposure to colder temperatures, and separation and precipitation of the paint composition during storage, and a thin consistency.

Previous attempt in trying to replace polyethylene glycol composition by substituting native starches and vegetables oil and other cheaper ingredients have been found unsuccessfully due to instability of chemical reaction within the fill materials.

Further in prior arts the fill material using native starches also found to be deteriorated due to lower swelling power and solubility, high retrogradation and syneresis according to FIG. 1 when the impact ruptured projectile capsule is stored for a period of acceptable temperature ranging from 18 to 35 degree Celsius.

Chemical incompatibilities have rendered the various compositions within the formulation to dissolve the gelatin shell or caused to migrating moisture content in the gelatin shell to the fill material, rendering the previous art of replacing polyethylene glycol composition unsuccessfully.

In particular, there is a need to improve the desirable attributes of the impact ruptured projectile capsules by enhancing the properties of the water soluble dye of the formulation within.

### SUMMARY OF THE INVENTION

The main objective in manufacturing cost effective lipophilic carrier for present enhanced water soluble dye is to overcome the setback in the prior art that is caused by its instability with the impact ruptured projectile capsules gelatin shell and within the fill composition.

Further in prior art there is a disclosure of the drawbacks of using native starches with vegetables oil or polyethylene glycol based composition in manufacturing impact ruptured projectile capsules fill material. Such drawbacks were highlighted as FIG. 3 in reduced surface area of the resulting impact ruptured projectile capsules hit because the filler of previous invention is thicker in consistency of other prior art.

Secondly, the use of the impact ruptured projectile capsules of prior art is limited mostly for cold or cool weather since the filler starts to deteriorate when temperature is ranging from 18 to 25 degree Celsius as shown in FIG. 1.

Prior arts of making the same has failed to neither notify, specifically identify, disclose nor recognize the important role of modified starches and shortening oil added into water soluble dye enhanced composition.

Therefore, the present inventor has improved in making enhanced water soluble dye formulation and subsequently discovered the most suitable modified oxidized starches in the present of shortening oil FL30™ with vegetables oil or polyethylene glycol base as a new combination composition in preparing enhanced water soluble dye for impact ruptured projectile capsules, thereby completed the present invention.

Accordingly, it is an object of the present invention to improve the prior art of preparing native starches mixed with vegetables oil or polyethylene glycol based composition aforesaid, include (1) significantly improved on cost effective, (2) consistency and stability without any moisture migration between gelatin shell and the enhanced fill composition, (3) solved bad separation of ingredients between starches with vegetables oil or polyethylene glycol and prevent mixture becomes paste, sticky or semi-solid substance, (4) less thickness with less viscosity and free flowing attribution for greater splattering of paint without dipping on target surface upon impact and rupture of the gelatin shell, (5) completely washable solubility, (6) non shifting during flight and increase accuracy in hitting a target upon firing by using projectile air gun device, (7) improved machine washability and (8) easily control and regulate fills material being injected into impact ruptured projectile capsules using rotary die technology during mass production encapsulation process.

Based on the aforesaid improvement, new combination composition of modified oxidized starches in the present of shortening oil FL30™ with vegetables oil or modified oxidized starches with polyethylene glycol base in this present invention have clearly established substantially non-equivalence composition leading to difference technical contribution in enhanced water soluble dye formulation in preparing impact ruptured projectile capsule.

Accordingly, it is of importance to the present invention that the gelatin shell of the impact ruptured projectile capsules be chemically stable with the water soluble dye enhanced formulation.

### BRIEF DESCRIPTION OF THE DRAWINGS/PHOTOGRAPHS

The file of this patent contains at least one drawing/photograph executed in color. Those mentioned copies of this patent with color drawings/photographs will be provided by the Patent and Trademark Office upon request and payment of the necessary fee.

FIG. 1 is a drawing showing “OO” denotes vegetables oil or polyethylene glycol separates badly from “HOH” combination of native starches with vegetables oil or polyethylene glycol, and “HH” denotes native starches completely separated from the later and become solid substance in prior art of dye composition.

FIG. 2 is a drawing showing “X” the enhanced composition of modified oxidized starches blended with “O” shortening oil FL30™ and vegetables oil or polyethylene glycol still “intact” indicated by “XOX” chemical binding stability throughout a period of time storage given temperature is ranging from 18 to 35 degrees Celsius.

FIG. 3 highlighted in reduced surface area of the resulting impact ruptured projectile capsules hit because the filler of prior art invention is thicker in consistency of other.

FIG. 4 is showing present invention of less thickness with less viscosity and free flowing attribution for greater splattering of paint without dipping on target surface upon impact and rupture of the gelatin shell.

FIG. 5(A) of microphotograph is showing prior art of native starches granule.

FIG. 5(B) of microphotograph is showing present invention of modified oxidized starches granule.

FIG. 6(A) of microphotograph is showing present invention of crystal distribution in shortening oil new fluid FL30™. Crystal of homogeneous size and distribution indicates good fluidity and solubility.

FIG. 6(B) of microphotograph is showing the crystal distribution in solid shortening oil indicates poor fluidity and non flexible solubility.

### DETAILED DESCRIPTION OF THE INVENTION

The term used in impact ruptured projectile capsules is referring to capsules made of gelatin shell is spherical in shape containing a new combination of modified oxidized starches in the present of shortening oil FL30™ blended with vegetables oil or polyethylene glycol, emulsifier agent and dye color, said projectile capsule shell is made of gelatin shell and is subjected to rupture upon hitting on target with a solid or non solid surface or contact.

The impact ruptured projectile capsules described herein is not intended to be limited to a spherical in shape within the content of this present invention.

The term “projectile”, “marking pellet”, “projectile capsules”, “target shooting capsules”, “rupturable capsule”, “paintballs” and “impact ruptured projectile capsule” are used interchangeably.

Further the term “water soluble dye”, “lipophilic carrier”, “core projectile”, “fill formulation”, “fill material”, “inner filler composition”, “liquid colorant composition”, “washable marking fluid composition” and “water soluble oil paint” are used interchangeably.

Impact ruptured projectile capsule is a popular sporting activity whereby in one form of this game, players on each teams are supplied with a projectile air gun device and a number of impact ruptured projectile capsule which are spherical in shape of ammunition.

Projectile air gun fires these impact ruptured projectile capsule using compressed gas (CO2 or N2, etc) as a propellant. When a player is hit with an impact ruptured projectile capsule, the projectile capsule shell ruptures to cause enhanced water soluble dye splattering on the target surface providing dramatic visible evidence of the hit, without injuring the player.

The impact ruptured projectile capsule shell is made of gelatin, starches, food grade color and other ingredients which are biodegradable. This impact ruptured projectile capsule is used to encapsulate enhanced water soluble dye using rotary die technology as similar to soft capsule method of making.

In the preferred enhanced water soluble dye, the vegetables oils used in accordance with the present invention can include vegetable oils. Such vegetables oil include, but are not limited to soybean oil, corn oil, sunflower oil, cereal oil, peanut oil, oil palm, coconut oil, shortening oil, olive oil, rapeseed oil, canola oil, pumpkin seed oil, rice oil, safflower oil and the like.

Other oleaginous oil include but are not limited to fish oil, walnut oil, almond oil, hemp oil, jojoba oil, oiticica oil, meadowfoam oil, linseed oil, polyethylene glycol, sesame oil, cottonseed oil, mineral oil, castor oil and paraffin oil.

In the preferred embodiment, shortening oil FL30™ is used but are not limited to a group of blended vegetables oil or polyethylene glycol base aforesaid. The blended shortening oil FL30™ with vegetables oil or polyethylene glycol base can be present in an amount ranging from about 20% to 95% by weight of the total composition. Preferably, the blended shortening oil FL30™ with vegetables oil or polyethylene glycol base is present in amount ranging from about 45% to about 80% by weight of the total composition.

Emulsifying agent is used as a binding agent between two usually non compatible materials. It is preferable to use either any one or combination thereof selected from the following but are not limited to ethoxylated sorbitan esters, ethoxylated triglycerides, ethoxylated glyceryl esters, ethoxylated fatty acids, ethoxylated fatty alcohols, ethoxylated fatty acids, polyol esters, beewaxes, lecithin, paraffin waxes and emulsifying waxes.

Those who are skillful with enhanced knowledge in this art will be able to identify either any one or combination thereof among the emulsifying agents to bind the non compatible materials subject to the application and result needed.

The emulsifying agents aforesaid are used in but are not limited to preservative purpose, protective coating for powders, a solidifier and stabling pharmaceuticals fills material, additive in water based printing oil or cosmetic, detergent agent, viscosity conditioning agent, solubility agent, dispersing agent, leveling agent, wetting agent, antistatic agent, foaming agent, vegetables oil emulsion, foam stabilizer agent, suspension agent, lubricant agent and chemical intermediate agent.

The emulsifier can be present in an amount sufficient to provide a stable emulsion in accordance to the storage and usage temperatures. Preferably, the emulsifier can be added in the composition from 0.01% to about 20% by weight of the total composition. More preferably, the emulsifier is present in an amount ranging from 0.01% to 10% by weight of the total composition.

In a preferred embodiment of the present invention, new composition of modified oxidized starches are preferably to use or combination thereof among the following classification but are not limited to physically modified starch, pregelatinization modified starch, enzymatically modified starch, resistant modified starch, dextrin starch (E1400), acid treated starch (E1401), alkaline treated starch (E1402), bleached starch (E1403), oxidized starch (E1404), enzyme-treated starch (E1405), monostarch phosphate (E1410), distarch glycerol (E1411), distarch phosphate esterified with sodium trimetaphosphate (E1412), phosphated distarch phosphate (E1413), acetylated distarch phosphate (E1414), starch acetate esterified with acetic anhydride (E1420), starch acetate esterified with vinyl acetate (E1421), acetylated distarch adipate (E1422), acetylated distarch glycerol (E1423), hydroxypropyl starch (E1440), hydroxypropyl distarch phosphate (E1442), hydroxypropyl distarch glycerol (E1443), starch sodium octenyl succinate (E1450) and acetylated oxidize starch (E1451).

More preferably, modified oxidized starch is selected or combination thereof among others may be used subject to the binding proportion and will vary subject to the viscosity properties desired.

In a preferred embodiment, a selected modified oxidized starch or combination thereof among others are used in the composition ranging from 10% to 70% of the total weight composition.

More preferably a selected modified oxidized starch or combination thereof among others maybe added into the composition ranging from 20% to 60% of the total weight composition.

In a preferred embodiment of the present invention, modified oxidized starch is added into the enhanced composition in the present of shortening oil FL30™ to improve over prior arts of preparing native starches with vegetables oil or polyethylene glycol base impact ruptured projectile capsules fill material.

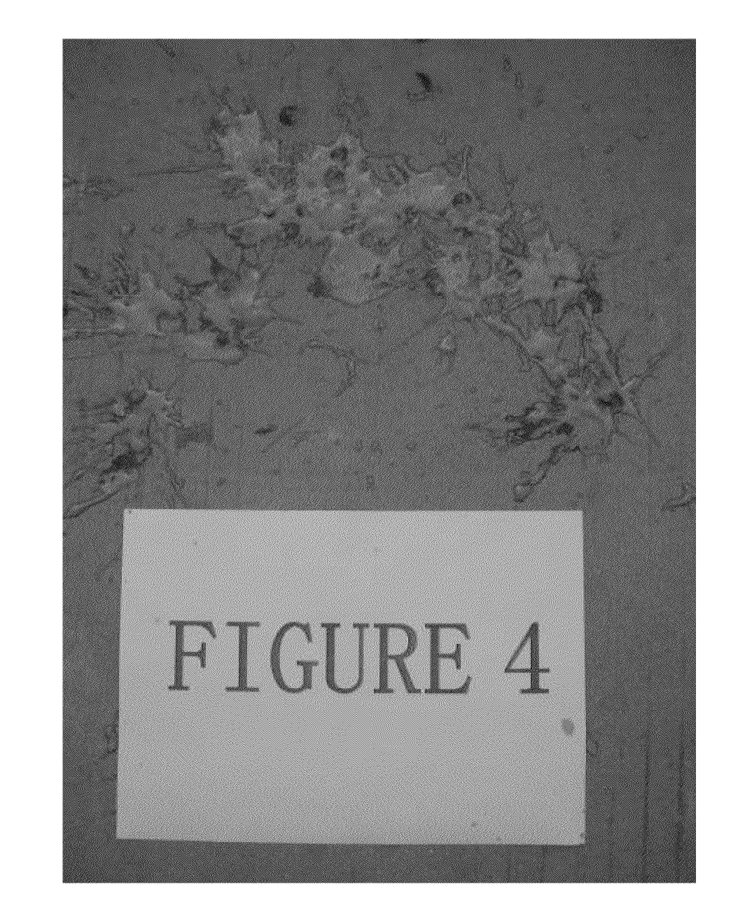

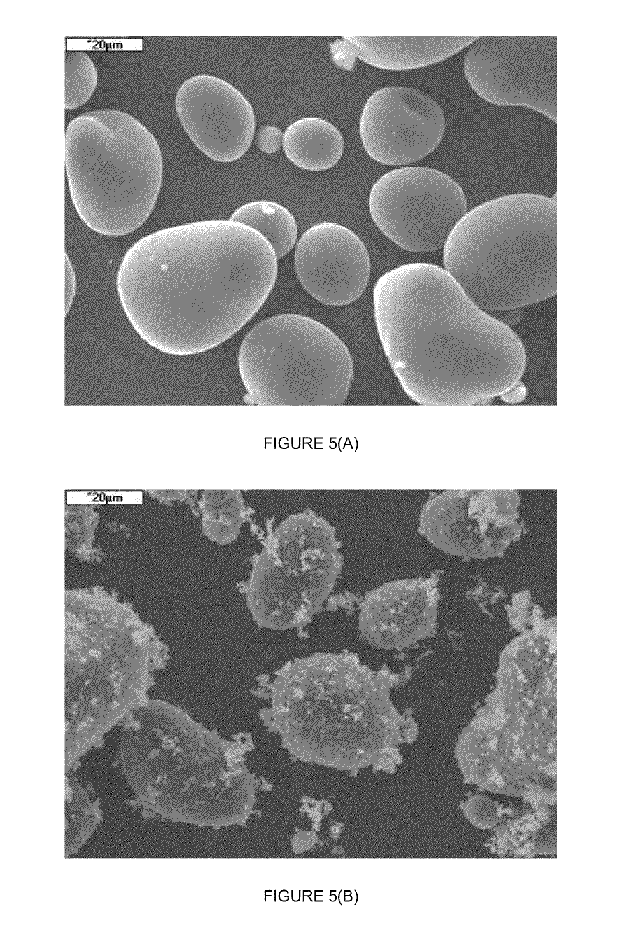

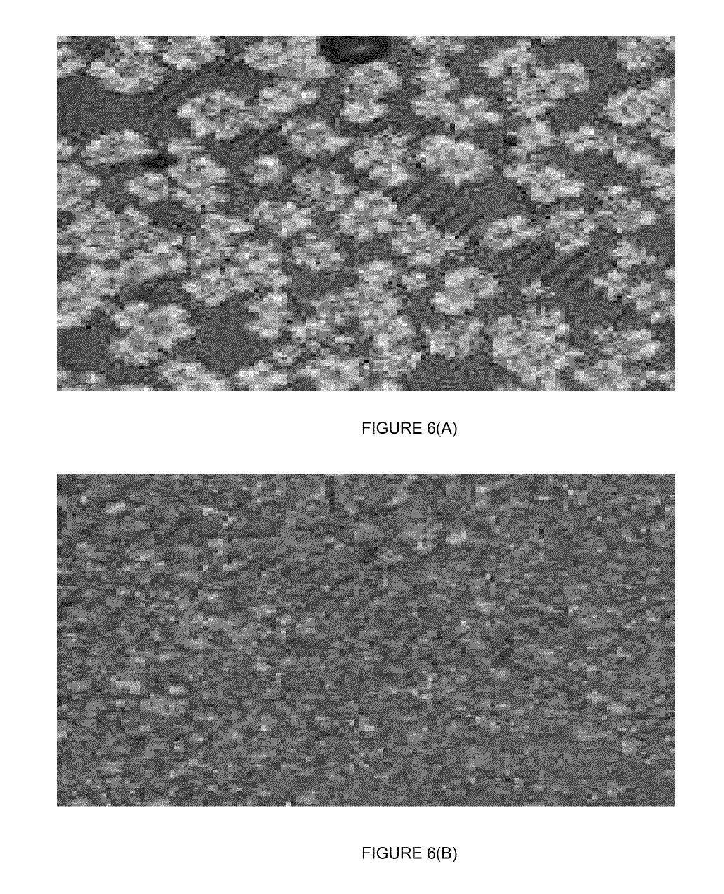

The proportion of mixture between modified oxidized starch and blended shortening oil FL30 with vegetables oil or polyethylene glycol base are important to determine the viscosity of the final prepared fill material composition. The present invention is intended but is not limited to prepare a less viscosity, free flowing attribution with less thickness for greater splattering of paint without dipping on target surface upon impact and rupture of the gelatin shell as shown in FIG. 4.

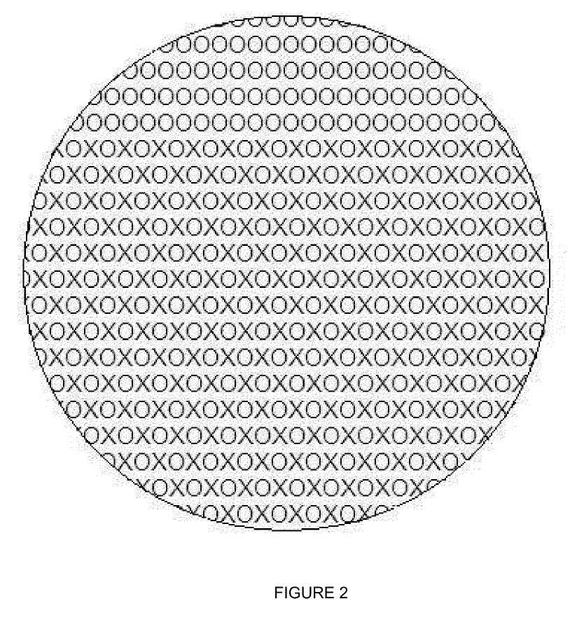

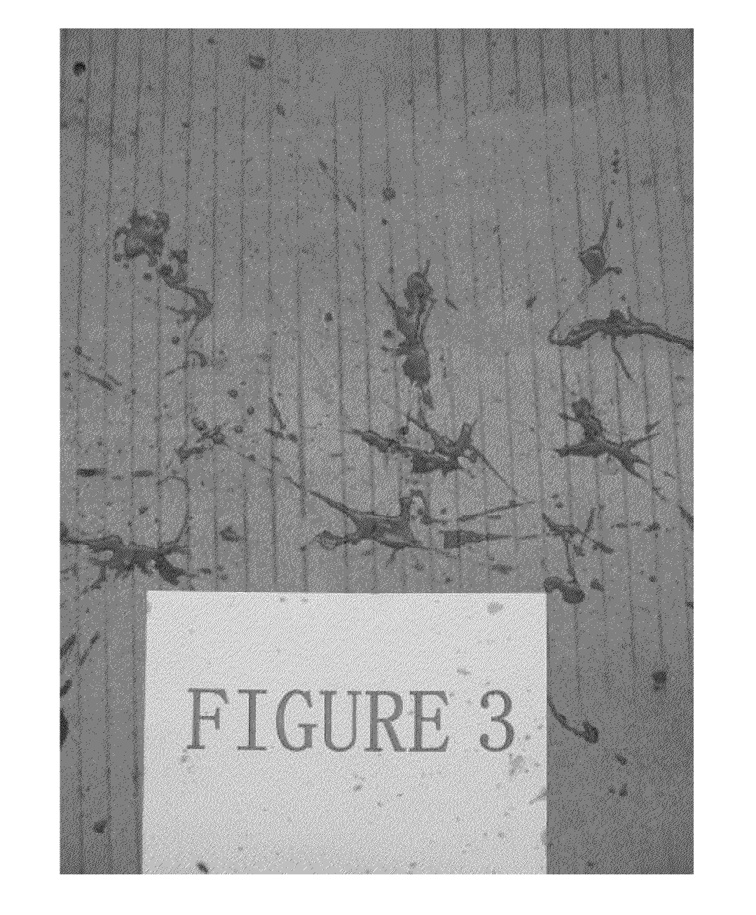

New combination composition of modified oxidized starch aforesaid blended chemical binding stability in the present of shortening oil FL30™ with vegetables oil or polyethylene glycol base is due to high binding capacity to produce less viscosity enhanced fill composition according to FIG. 2.

A less viscosity, free flowing attribution with less thickness fill material in this present invention has improved over prior art of making native starches/oil based fill material and produced a non-shifting fill composition encapsulated into impact ruptured projectile capsule. The non-shifting fill composition during flight will increase accuracy in hitting a target upon firing by using projectile air gun device.

In the prior art of preparing native starches with vegetables oil or polyethylene glycol fill material for less viscosity solution, it was noted clearly that native starches, other suitable biomass food filler, bioorganic flour and native powder do not have the chemical binding stability caused by retrogradation, syneresis and lower swelling power in free flowing solubility. Native starches, other suitable biomass food filler, bioorganic flour and native powder only act as thickener agent or density agent.

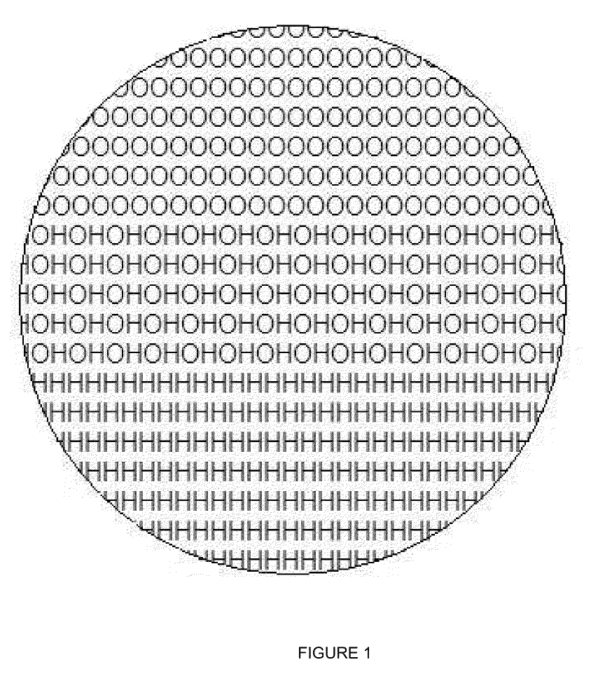

Without modified oxidized starch and shortening oil FL30™ aforesaid present in starches with vegetables oil or starches with polyethylene glycol formulation being acted as high binding capacity, there is tend to observe bad separation between starches and vegetables oil or polyethylene glycol as shown in FIG. 1 within short period of storage time given temperature ranging about 18 to 35 degree Celsius.

The high binding capacity of modified oxidized starches blended in the present of shortening oil FL30™ with vegetables oil or polyethylene glycol can be explained according to the following mentioned below.

The oxidation process leads to a decrease in the amount of phosphorus and linear fraction-amylose in the modified oxidized starches. The result of the oxidation process is an increase in the number of carboxylic and carbonyl groups with a clear preference of forming those latter.

The modified oxidized starches over catalyst are characterized by lower viscosity in comparison to the native starch, which results from starch deploymerization during the reaction of oxidation.

According to FIG. 7(B), it is evident by a big number of the carbonyl groups. Binding stability and solubility prepared from modified oxidized starches, in comparison to thickening made from native starch is many times stronger due to the presence of the carboxylic and carbonyl groups in these modified oxidized starches.

Addition of acetyl groups interfere with the regrouping of amylose and amylopectin during gelatinization generated more linear segments eases the absorption of higher amount of iodine, reflected in the amylose content which depends on the number of acetyl groups incorporated.

These acetyl groups considered increased solubility due to better dispersion of starch in aqueous systems because acetyl groups obstruct chain association.

Therefore, the chemical binding stability over retrogradation, syneresis, swelling power and solubility can be resolved using acetylation, oxidization, cross-linked and hydroxypropylation processes in accordance to different type of starches, size and shape of its molecular components and the method of pretreatment.

Shortening oil FL30™ according to FIG. 8(A) demonstrated good crystal in the beta prime β form in homogeneous size and distribution indicates good fluidity and solubility.

Therefore, shortening oil FL30™ blended compatible with vegetables oil or polyethylene glycol and modified oxidized starches to produce less viscosity enhanced water soluble dye composition according to FIG. 2.

Modified oxidized starches make the starches more hydrophilic (water loving) and aid cross-linking. This makes modified oxidized starch useful in detergent agent that contributed in completely washable dye solubility and is identified non staining paint.

Modified oxidized starch bind compatible with blended shortening oil FL30™ and vegetables oil or polyethylene glycol due to binding attribution that do not cause expansion within the fill material during summer season. Unlike prior art of making the same, fill material tends to react expansion when it exposes to heat that caused the impact ruptured projectile capsules out of shape.

The modified starches selected from the aforesaid have attributed new improvement in water soluble dye enhanced formulation from the functional classes but are not limited to dye coating, detergent builders, reduce retrogradation and syneresis, increase swelling powder and solubility, paste stabilizer and high capacity in chemical binder with oil for free flowing attribution.

Those aforesaid are new attributions being discovered in the new improvement of enhanced water soluble dye composition for preparing impact ruptured projectile capsules fill material.

The dye coloring can be present in an amount sufficient to cause the composition with appearance coloration. The FD&C dye can be present in an amount ranging from 0.01% to about 10% by weight of the total composition. Preferably, the FD&C is added in an amount of about 0.05% to 5% by weight of the total composition.

A variety of colors can be used as the dye ingredient of the present invention. The liquid dye composition can be colored red, blue, yellow, orange, purple, green, violet, gold and the like. Typically, high visible neon colors are used including fluorescent versions of colors.

Generally, there is a standard industry size being used to determine the size, dimension, or weight of the impact ruptured projectile capsule. In a preferred embodiment, the impact ruptured projectile capsule in sporting activity come in the size ranging from 0.40-0.70 caliber, or an approximately of 0.68 caliber.

An average impact ruptured projectile capsule weights between approximately 2.0 g to 4.0 g, and preferably 2.8 g to 3.5 g, so that an impact ruptured projectile capsule operates with a known projectile air gun, loader of ammunition and other equipment.

Accordingly, the new improvement composition in enhanced water soluble dye for impact ruptured projectile capsule have significantly contributed by providing an impact ruptured projectile capsules that is efficient to manufacture, low cost, and safe to the environment.

There is a need for an impact ruptured projectile capsule that is formed other than as a purely liquid or purely oil and or purely polyethylene glycol filled in impact ruptured projectile capsule.

In addition, there exists the need for an impact ruptured projectile capsule formed from available material that may be acquired and processed at low cost.

The method based on common general knowledge of an ordinary person for preparing the present invention water soluble dye fill material compositions is mentioned below.

A group of blended oils or polyethylene glycol are added to a suitable mixing vessel equipped with a disperser blade. Mixing is initiated and the mixing speed adjusted to the optimum that does not incorporate air into the liquid mixture.

A second group of composition is to be added to the mixing vessel together with a well blended mixture of a group of emulsifying agents, modified starches and thickening agents to the said composition.

The vegetable oil or polyethylene glycol together with a group of blended mixture is heated to the temperature ranging from 50 degree Celsius to about 90 degree Celsius.

The dye or color pigment may be added with or without additional water, where the dye or color pigment is water soluble, it is generally added as an aqueous solution.

To ensure the composition is free of solids, the pigment and dye mixtures are passed through, for example, a 200 mesh screen, as they added to the mixture vessel. Mixing of the composition is continued until the color pigment or dye is well blended and uniform.

The fill composition is to be cold down to about room temperature before encapsulating within the impact ruptured projectile capsules using the rotary die encapsulation method, a similar process being practiced in soft gel capsules production.

The following examples demonstrate certain aspects of the present invention. However, it is to be understood that these examples are for illustrative purpose only and do not purport to be wholly definitive as to conditions and scope of the present invention.

It also should be appreciated that when typical reaction conditions, for example, temperature and reaction times which are those specific ranges can be used, though generally less conveniently.

### EXAMPLE 1

### Stability of Paste Modified Oxidized Starch and Native Starches

| | Transmittance (%) | Transmittance (%) |
|---|---|---|
| Time (h) | Modified Oxidized Starch | Native starches |
| 0 hour | 0.50 | 1.8 |
| 24 hours | 0.25 | 0.5 |
| 48 hours | 0.20 | 0.4 |
| 72 hours | 0.18 | 0.3 |

Starches were modified in oxidization processes to determine stability and clarity of starch paste at room temperature. At low temperature ranging from 18 to 25 degree celsius increases starch retrogradation phenomenon. Retrogradation consists of two separable processes, gelation of amylose molecules exuded from the granules during gelatinization and recrystallization of amylopectin.

Amylose gelation proceeds via formation of left handed double helical chain segments, followed by helix-helix aggregation of B-type structure. Starch in this sample processed into modified oxidized starch showed the lowest % transmittance value (retrogradation rate) than native starches.

The presence of acetyl groups interferes with the regrouping of amylose and amylopectin during cooling of the starch molecules that have been subjected to gelatinization. Based on this evident, the generation of more linear segments eases the absorption of higher amount of iodine, reflected in the amylose content which depends on the number of acetyl groups incorporated.

These acetyl groups considered increased solubility due to better dispersion of starch in aqueous systems because acetyl groups obstruct chain association. Modified oxidized starch presented higher solubility values than common native starches due to different chain length distribution in these starches.

Swelling power values of modified oxidized starches may be explained by the introduction of hydrophilic substitution groups, allowing the retention of water molecules because of their ability to form hydrogen bonds. The granule size and supramolecular organization of starch components is an important role in this solubility pattern.

### EXAMPLE 2

### Carbonyl (%) in Modified Oxidized Starches and Native Starches

| Amount of catalyst (g) | Content of carbonyl groups (%) |
|---|---|
| Native starches | 0.01 |
| Modified Oxidized Starches:- | |
| 0 g ZnO | 0.06 |
| 10 g ZnO | 0.38 |
| 20 g ZnO | 0.30 |
| 30 g ZnO | 0.14 |

The content of carbonyl groups in the modified oxidized starch over addition of ZnO catalyst was many times (in some samples even 22-times) higher than the content in native starch. It should be stated that the highest chemical binding stability was characteristic for pastes prepared from starches with the lowest addition of catalyst because it showed the highest number of carbonyl groups.

Such a big content of the carbonyl groups in the modified oxidized starches can probably be connected with reaction of hydrolysis taking place during oxidation and resulting in depolymerization of the starch.

It was confirmed by determining viscosity of paste made from the modified oxidized starches, using a Barbender viscometer, because the viscosity of these pastes is much lower in regard to the native starch. Accordingly an integral part of starch oxidation is a hydrolysis of this polysaccharide resulting in obtaining a big number of the carbonyl groups.

### EXAMPLE 3

### Aqueous Solubility (S) and Binding Capacity (BC)

| | 25° C. | | 40° C. | | 60° C. | |
|---|---|---|---|---|---|---|
| Amount of | S | BC | S | BC | S | BC |
| catalyst [g] | [%] | [g/1 g s.s.] | [%] | [g/1 g s.s.] | [%] | [g/1 g s.s.] |
| Native starch | 0.13 | 0.92 | 0.21 | 0.95 | 0.27 | 0.96 |
| Modified | | | | | | |
| oxidized starch: | | | | | | |
| 0 g ZnO | 0.14 | 1.15 | 0.35 | 1.14 | 1.27 | 1.18 |
| 10 g ZnO | 1.36 | 1.66 | 1.47 | 1.62 | 2.11 | 1.89 |
| 20 g ZnO | 1.30 | 1.65 | 1.13 | 1.60 | 1.54 | 1.80 |
| 30 g ZnO | 1.22 | 1.40 | 1.12 | 1.34 | 1.38 | 1.54 |

The highest solubility was characterized for the modified oxidized starches with the smallest addition of the catalyst. It was stated that the biggest amount of the catalyst was used, solubility was decreasing within the analyzed the range of temperatures.

Binding capacity of the modified oxidized starches over Zn catalyst was also higher compared to native starches and was decreasing along with the increase amount of the used catalyst.

It is worth emphasizing that modified oxidized starches containing a big amount of the carbonyl groups were characterized by higher binding capacity and solubility due to decreasing length of starch chain.

### EXAMPLE 4

### Carboxylic (%) in Modified Oxidized Starches and Native Starches

| | Content of carboxylic groups |
|---|---|
| Amount of catalyst (g) | (%) |
| Native starches | 0.00 |
| Modified Oxidized Starches:- | |
| 0 g ZnO | 0.10 |
| 10 g ZnO | 0.16 |
| 20 g ZnO | 0.21 |
| 30 g ZnO | 0.23 |

It can be concluded the content of the carboxylic rather than the carbonyl ones is a determiner of starch oxidation. It is so, because the carbonyl groups are the results of side effect of hydrolysis in the process of oxidation.

Based on the illustration example results, it can be concluded that native starches have limitation due to shear stress resistance, thermal decomposition, high retrogradation and syneresis, low swelling power and solubility. However, these shortcomings can be overcome but is not limited to carbonyl and carboxylic groups, acetylation, oxidization, cross-linked, physically modified, enzymatically modified, acid or alkaline treated and hydroxypropylation processes in accordance to different type of starches, size and shape of its molecular components and the method of pretreatment.

Therefore, it is of the objective of the present invention to prepare cost effective, low cost ingredients to process modified oxidized starch in water soluble dye enhanced composition for impact ruptured projectile capsules.

According to the aforesaid, it is understood that the present invention is not limited to the particular embodiments shown and described herein, but that various changes and modifications may be made without departing from the scope and spirit of the invention.

What is claimed is:

1. A new improvement in enhanced water soluble dye composition adapted for use in an impact ruptured projectile capsules comprising new combination of modified oxidized starches in the present of shortening oil FL30™ blended with vegetables oil or polyethylene glycol base, dye color, emulsifier and thickener agent.

2. The enhanced water soluble dye composition according to claim 1 wherein the impact ruptured projectile capsules is spherical in shape.

3. The enhanced water soluble dye composition according to claim 1 wherein the emulsifying agent preferable to use either any one or combination thereof selected from the following but are not limited to ethoxylated sorbitan esters, ethoxylated triglycerides, ethoxylated glyceryl esters, ethoxylated fatty acids, ethoxylated fatty alcohols, ethoxylated fatty acids, polyol esters, beewaxes, lecithin, paraffin waxes and emulsifying waxes.

4. The enhanced water soluble dye composition according to claim 3 wherein the emulsifier are present in an amount ranging from about 0.01% to about 10% by weight of the total composition.

5. The enhanced water soluble dye composition according to claim 1 further comprising at least one modified starches.

6. The enhanced water soluble dye composition according to claim 5 wherein the new composition of modified oxidized starches are preferably to use or combination thereof among the classification but are not limited to physically modified starch, pregelatinization modified starch, enzymatically modified starch, resistant modified starch, dextrin starch (E1400), acid treated starch (E1401), alkaline treated starch (E1402), bleached starch (E1403), oxidized starch (E1404), enzyme-treated starch (E1405), monostarch phosphate (E1410), distarch glycerol (E1411), distarch phosphate esterified with sodium trimetaphosphate (E1412), phosphated distarch phosphate (E1413), acetylated distarch phosphate (E1414), starch acetate esterified with acetic anhydride (E1420), starch acetate esterified with vinyl acetate (E1421), acetylated distarch adipate (E1422), acetylated distarch glycerol (E1423), hydroxypropyl starch (E1440), hydroxypropyl distarch phosphate (E1442), hydroxypropyl distarch glycerol (E1443), starch sodium octenyl succinate (E1450) and acetylated oxidize starch (E1451).

7. The enhanced water soluble dye composition according to claim 6 wherein the modified starches are present in an amount ranging from about 20% to about 60% by weight of the total composition

8. The high binding capacity of modified oxidized starches blended in the present of shortening oil FL30™ with vegetables oil or combination with polyethylene glycol base can be explained according to the following mentioned below.

9. The oxidation process leads to a decrease in the amount of phosphorus and linear fraction-amylose in the modified oxidized starches. The result of the oxidation process is an increase in the number of carboxylic and carbonyl groups with a clear preference of forming those latter.

10. The modified oxidized starches over catalyst are characterized by lower viscosity in comparison to the native starch, which results from starch depolymerization during the reaction of oxidation.

11. It is evident by a big number of the carbonyl groups. Binding stability and solubility prepared from modified oxidized starches, in comparison to thickening made from native starch is many times stronger due to the presence of the carboxylic and carbonyl groups in these modified oxidized starches.

12. The presence of acetyl groups interferes with the regrouping of amylose and amylopectin during cooling of the starch molecules that have been subjected to gelatinization. Based on this evident, the generation of more linear segments eases the absorption of higher amount of iodine, reflected in the amylose content which depends on the number of acetyl groups incorporated.

13. Acetyl group considered increased solubility due to better dispersion of starch in aqueous systems because acetyl groups obstruct chain association. Modified oxidized starch presented higher solubility values than common native starches due to different chain length distribution in these starches.

14. Swelling power values of modified oxidized starches may be explained by the introduction of hydrophilic substitution groups, allowing the retention of water molecules because of their ability to form hydrogen bonds. The granule size and supramolecular organization of starch components is an important role in this solubility pattern.

15. Based on the claimed 8 to 14 it can be concluded that native starches have limitation due to shear stress resistance, thermal decomposition, high retrogradation and syneresis, low swelling power and solubility. However, these shortcomings can be overcome but is not limited to carbonyl and carboxylic groups, acetylation, oxidization, cross-linked, physically modified, enzymatically modified, acid or alkaline treated and hydroxypropylation processes in accordance to different type of starches, size and shape of its molecular components and the method of pretreatment.

16. Shortening oil FL30™ demonstrated good crystal in the beta prime β form in homogeneous size and distribution indicates good fluidity and solubility.

17. The modified starches selected from the aforesaid have attributed new improvement in water soluble dye enhanced formulation from the functional classes but are not limited to dye coating, detergent builders, reduce retrogradation and syneresis, increase swelling powder, paste stabilizer and high capacity in chemical binder with oil or polyethylene glycol for free flowing attribution

18. In the prior art of preparing native starches/oil fill material for less viscosity solution, it was noted clearly that based on enhanced knowledge of a skillful person in this art, native starches, other suitable biomass food filler, bioorganic flour and native powder do not have the chemical binding stability caused by retrogradation, syneresis and lower swelling power in free flowing solubility.

19. According to claim 18, native starches, other suitable biomass food filler, bioorganic flour and native powder only act as thickener agent or density agent.

20. An impact ruptured projectile capsules according to claim 1 wherein the enhanced water soluble dye composition improve the prior art include (1) significantly improved on cost effective, (2) consistency and stability without any moisture migration between gelatin shell and the enhanced fill composition, (3) solved bad separation of ingredients between starches with vegetable oil or polyethylene glycol and prevent mixture becomes paste, sticky or semi-solid substance, (4) less thickness with less viscosity and free flowing attribution for greater splattering of paint without dipping on target surface upon impact and rupture of the gelatin shell, (5) completely washable solubility, (6) non shifting during flight and increase accuracy in hitting a target upon firing by using projectile air gun device, (7) improved machine washability and (8) easily control and regulate fills material being injected into impact ruptured projectile capsules using rotary die technology during mass production encapsulation process.

21. The enhanced water soluble dye composition formulation according to claim 1 be chemically stable with impact ruptured projectile capsules gelatin shell and within fill composition during drying process and long term storage at acceptable exposure to temperature.

22. Based on the aforesaid claims, new combination of modified oxidized starches in the present of shortening oil FL30™ with vegetables oil or polyethylene glycol base in this present invention have clearly established substantially non-equivalence composition leading to difference technical contribution in enhanced water soluble dye formulation in preparing impact ruptured projectile capsule.
